(19) United States
(12) Patent Application Publication
(10) Pub. No.: US 2016/0002457 A1
(43) Pub. Date: Jan. 7, 2016

(54) TUNABLE AND RESPONSIVE PHOTONIC HYDROGELS COMPRISING NANOCRYSTALLINE CELLULOSE

(71) Applicants: CELLUFORCE INC., Montréal (CA); UNIVERSITY OF BRITISH COLUMBIA, Vancouver (CA)

(72) Inventors: Wadood Yasser HAMAD, Vancouver (CA); Mark John MACLACHLAN, Vancouver (CA); Joel Alexander KELLY, Vancouver (CA); Kevin Eric SHOPSOWITZ, Brookline, MA (US)

(73) Assignees: Celluforce Inc., Montreal (CA); University of British Columbia, Vancouver (CA)

(21) Appl. No.: 14/768,974

(22) PCT Filed: Feb. 12, 2014
(86) PCT No.: PCT/CA2014/050096

§ 371 Date: Aug. 19, 2015

Related U.S. Application Data
(60) Provisional application No. 61/766,863, filed on Feb. 20, 2013.

(51) Int. Cl. C08L 33/26; C08L 33/02; C08L 33/14

(52) U.S. Cl. CPC C08L 33/26; C08L 33/14; C08L 33/02

(57) ABSTRACT

Composite hydrogels with a chiral organization with tunable responsive photonic properties are conceived. A polymerizable hydrophilic monomer such as acrylamide is reacted in the presence of nanocrystalline cellulose (NCC) to give a composite hydrogel with cellulose nanocrystals embedded in a chiral nematic organization. Through control of the reaction conditions, the hydrogel can exhibit photonic colour that can be varied throughout the visible and near-infrared regions. The colour shifts substantially and reversibly upon swelling and shrinking of the hydrogel through solvation in aqueous and nonaqueous media. The responsive properties can be tailored both through choice of monomer and/or through chemical modification of the NCC surface. Examples of possible applications of the materials are: tunable reflective filters, chemical sensors, stationary phases for electrophoresis of chiral or achiral substances, and as a template to generate new materials with chiral nematic structures.

### FIELD OF THE DISCLOSURE

The present invention relates to novel polymeric composite hydrogels, their method of preparation and uses thereof.

### BACKGROUND OF THE DISCLOSURE

Hydrogels are three-dimensional networks of cross-linked hydrophilic polymers distinguished by their ability to swell and absorb large volumes of water without dissolving. Hydrogels can be composed of a wide variety of natural and synthetic polymers, giving access to a diverse range of physical properties and potential applications. For example, hydrogels are used commercially as superabsorbent materials, in contact lenses, and in many biomedical applications such as wound dressings or tissue scaffolding.

Responsive hydrogels experience a reversible change in their properties in response to external stimuli such as pH, temperature or light, enabling their use in areas such as drug-delivery, medical implants or biosensor devices. One family of responsive hydrogels of particular interest are photonic hydrogels, which couple a reversible change in hydrogel properties with optical diffraction, resulting in significant changes in color as the hydrogel swells and contracts (Wu, Z. L. et al. NPG Asia Mater. 2011, 3, 57-64 and Moon, J. H. et al. Chem. Rev. 2010, 110, 547-574.

The International Standards Organisation (ISO) has stipulated that the use of the term cellulose nanocrystals (CNC), should replace nanocrystalline cellulose (NCC), however the two are used herein interchangeably.

### SUMMARY OF THE DISCLOSURE

In one aspect, there is provided a composite hydrogel comprising a polymer matrix and an intercalated network of nanocrystalline cellulose (NCC) substantially uniformly dispersed within said matrix wherein said polymer matrix is swellable in an aqueous and/or organic solvent and said polymer matrix is comprising at least one cross-linked hydrophilic polymer; wherein said NCC is organized in a chiral nematic structure.

In a further aspect, there is provided a process for producing the composite hydrogel as defined herein comprising:
preparing a solution of a hydrophilic monomer, a cross-linker and an initiator in a solvent;
providing a suspension of NCC in a solvent;
mixing said solution and said suspension to provide homogeneity;
optionally removing at least some of said solvent(s); and
polymerizing said monomer and crosslinking said cross-linker to form said composite hydrogel.

In a further aspect, there is provided a film comprising the composite hydrogel as defined herein.

Further still, there is provided an article comprising the composite hydrogel as defined herein.

In one aspect, there is provided a composite hydrogel prepared by the process as defined herein.

### BRIEF DESCRIPTION OF THE FIGURES

FIG. 1: UV/vis spectrum of a PAAm hydrogel from preparation 2 before and after soaking in water;

FIG. 2: UV/vis spectra of PAAm hydrogels from preparation 2 after polymerization showing the effect of added NaCl on their reflected color.

FIG. 3: UV/vis spectra of a PAAm hydrogel from preparation 2 after soaking in various concentrations of ethanol/water.

FIG. 4: Maximum reflected wavelength from a PAAm hydrogel from preparation 2 as a function of time during swelling in water and shrinking in ethanol

FIG. 5: CD spectrum of a PAAm hydrogel from preparation 2 after soaking in water and ethanol showing the reversible shift in reflected color.

FIG. 6: UV/vis comparison of swelling behaviour of PAAm, PNIPAm, PHEMa and PEGMa hydrogel (from preparations 2-5) after polymerization, swelling in water and in ethanol.

FIG. 7: UV/vis comparison of swelling behaviour of PAAm hydrogels from preparation 2 after cation exchange in water and ethanol.

FIG. 8: UV/vis spectra of a PNIPAm hydrogel from preparation 3 showing a blueshift in the reflected wavelength with increasing temperature.

### DETAILED DESCRIPTION OF THE EMBODIMENTS

In this invention, one or more monomers are polymerized in the presence of nanocrystalline cellulose (NCC), or cellulose nanocrystals, to create hydrogel composites with NCC organized in a chiral nematic structure.

Stable nanocrystals of cellulose may be obtained by sulfuric-acid hydrolysis of bulk cellulose. In water, suspensions of nanocrystalline cellulose (NCC) organize into a chiral nematic phase that can be preserved upon drying, resulting in iridescent films. Aqueous dispersions of nanocrystalline cellulose undergo evaporation-induced self-assembly in the presence of suitable hydrogel precursors. At any stage during the evaporation process, photo-polymerization, or polymerization under the exposure of, for instance, ultra-violet frequency in the electromagnetic spectrum (UV radiation), causes a three-dimensional polymer network to form, fixing the self-assembled structure in place. Under certain circumstances, it is also possible to use infra-red radiation as the source of photo-polymerization. In all photopolymerization reactions, the need for a photo-initiator is contemplated. By controlling reaction conditions such as evaporation time, ionic strength, and NCC, monomer and cross-linker concentration, the helical pitch of the chiral nematic phase can be controlled.

Under suitable conditions, the hydrogels can reflect visible light, and swelling of the hydrogel causes a significant red-shift in the reflected color. By applying masks that partially block or fully block the UV light used in the polymerization, it is possible to pattern features into the hydrogel. These responsive photonic hydrogel materials could be used in a range of practical applications, such as sensors, tunable optical filters, electrophoresis gels for separating chiral or nonchiral species, display features, security features, or templating other nanomaterials.

Nanocrystalline cellulose (NCC), also referred to as cellulose nanocrystals (CNC), prepared by sulfuric-acid hydrolysis of lignocellulosic biomass (for instance, kraft wood pulp), undergoes chiral nematic self-assembly in the presence of hydrogel precursors (i.e., monomer, cross-linker and polymerization initiator). NCC dispersions ranging from 1-10 wt % (preferably 1-6 wt %) may be used. The NCC content % wt in the final hydrogel composite can be from 10% to 90%; Preferably 50% to 80%.

As will be appreciated by a skilled person, various hydrogel precursors may also be employed, under the criteria that they do not disturb the NCC self-assembly process and do not precipitate during evaporation as their concentration increases.

In one embodiment, the polymer matrix of said composite hydrogel is consisting of at least one cross-linked hydrophilic polymer.

In one embodiment, the composite hydrogel is consisting of a polymer matrix and an intercalated network of nanocrystalline cellulose (NCC) and optionally a salt.

The monomers used to form the hydrogel are not limited to the examples described herein. Various other monomers reported for responsive photonic hydrogels such as acrylic acid and acrylate-based monomers (including the (meth) acrylic/acrylates) are contemplated as being useful in the context of this disclosure and may be employed to prepare hydrogel composites responsive to a variety of stimuli (e.g., pH, temperature, ionic strength, glucose). As examples in this disclosure, acrylamide (AAm), N-isopropylacrylamide (NIPAm), hydroxyethylmethacrylate (HEMa), poly(ethylene glycol) methacrylate (PEGMa) and acrylic acid (AAc) were used to prepare hydrogel composites with chiral nematic structure. Other suitable hydrophilic monomers include, by way of example, vinylpyrrolidone, and N-vinylformamide (NVF). The hydrogels may be made of different monomers so that a hydrogel copolymer may be formed.

In one embodiment, the process is using one monomer. In a further embodiment, the process is using a mixture of monomers (such as 2 or 3 or more). As a result, the composite hydrogel can be a homopolymer or a copolymer.

The cross-linkers used to form the hydrogel are not limited to the examples described herein. Examples of suitable organic cross-linkers include bis (meth)acrylate/(meth)acrylamide, i.e those crosslinkers having at least the prop-2-enoyl functional group covalently connected by a suitable linker such as N,N′-methylenebisacrylamide (bis) or ethyleneglycol dimethacrylate.

In one embodiment, the polymerization initiator is a photoinitiator. The photoinitiators used to form the hydrogel are not limited to the examples described herein. Various initiators could be used and examples of this includes 2,2-diethoxyacetophenone or 2-hydroxy-1-[4-(2-hydroxyethoxy)phenyl]-2-methyl-1-propanone (tradename Irgacure 2959).

In one embodiment, the process is comprising the steps of:
preparing a solution of a hydrophilic monomer, a cross-linker and an initiator in an organic solvent;
providing a suspension of NCC in an aqueous solvent;
mixing said solution and said suspension to provide homogeneity;
optionally removing at least some of said organic and/or aqueous solvents; and
polymerizing said monomer and crosslinking said cross-linker to form said composite hydrogel.

In one embodiment, the process comprises adding a salt before the step of polymerizing the monomer. In one embodiment, the salt can include metal salts such as chloroauric acid trihydrate, silver nitrate, potassium tetrachlorplatinate, chloroplatinic acid hexahydrate, potassium ferricyanide, iron sulfate heptahydrate, cobalt nitrate hexahydrate, nickel nitrate hexahydrate and zinc nitrate hexahydrate, and preferably sodium chloride.

In the process of this disclosure, the organic solvents useful for preparing a solution of the monomer and cross-linker is preferably a solvent that is miscible with water or an aqueous solvent. Examples of this include ethanol, acetone and methanol. however the solvent must not disrupt NCC self-assembly.

In one embodiment, the process as defined herein is further comprising effecting a cation exchange step after forming of said composite hydrogel.

Polarizing optical microscopy (POM) of an aqueous mixture of 3 wt. % NCC and polyacrylamide (PAAm) hydrogel precursors (50/1/1.5 ratio of monomer/cross-linker/photo-initiator) showed the formation of a fingerprint texture during evaporation, indicating the formation of the NCC chiral nematic phase, up to a loading of 8 wt. % hydrogel precursors. Samples of these mixtures were transferred to polystyrene Petri dishes and left under ambient conditions to evaporate to a desired concentration. Polymerization was performed by UV irradiation for 1 h, yielding a solid film that swells in water but does not dissolve.

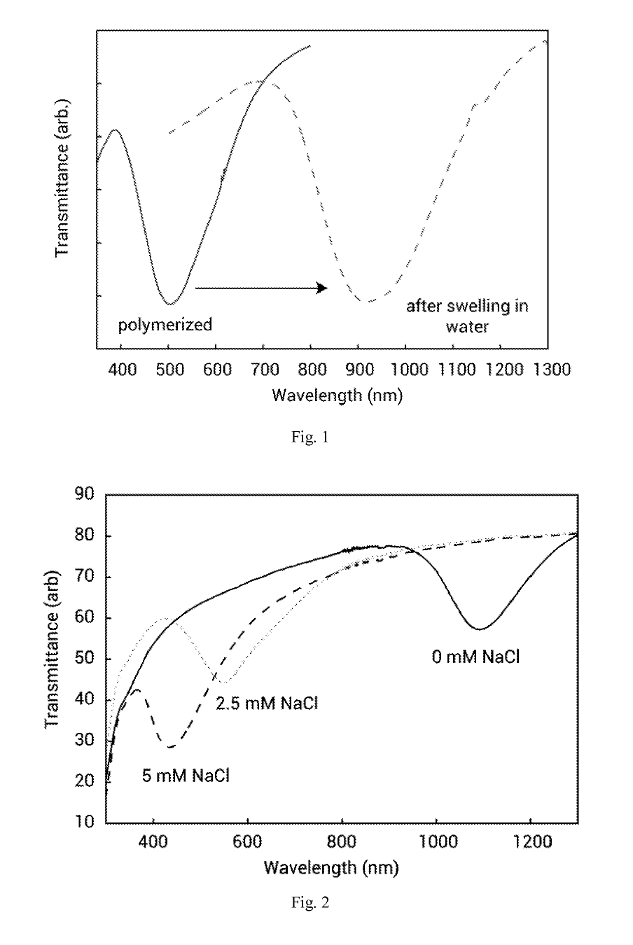

The helical pitch of the chiral nematic phase in these materials can be controlled by varying the evaporation time before polymerization, the NCC/polymer composition, and through increasing the ionic strength by adding salts such as sodium chloride. For example, evaporating a dispersion to a final concentration of 10.5 wt. % NCC, 17.4 wt. % acrylamide and 0.34 wt. % bis (Preparation 1) yields a PAAm hydrogel with a large chiral nematic pitch easily seen using POM. Conversely, evaporating a dispersion spiked with 6.5 mM sodium chloride to dryness (final concentration of 64.4 wt. % NCC, 33.5 wt. % acrylamide and 2.1 wt. % bis, Preparation 2) gives a PAAm hydrogel with blue iridescence, due to the helical pitch being on the order of the wavelengths of visible light (FIG. 1). Soaking the colored PAAm hydrogel in water swells the film, rapidly red-shifting the reflected colour as the helical pitch of the chiral nematic phase increases Increasing the ionic strength results in a blue-shift in the color of the hydrogel before swelling, as this is known to decrease the helical pitch in chiral nematic phases of NCC (FIG. 2) (see U.S. Pat. No. 5,629,055).

The self-assembly and polymerization process is compatible with a variety of substrates; for example, flexible films may be prepared by using polyester plastics containing surface acrylic groups, which covalently bond the hydrogel to the substrate. Masking the films during polymerization leaves behind a latent pattern that appears when the film is swollen in water.

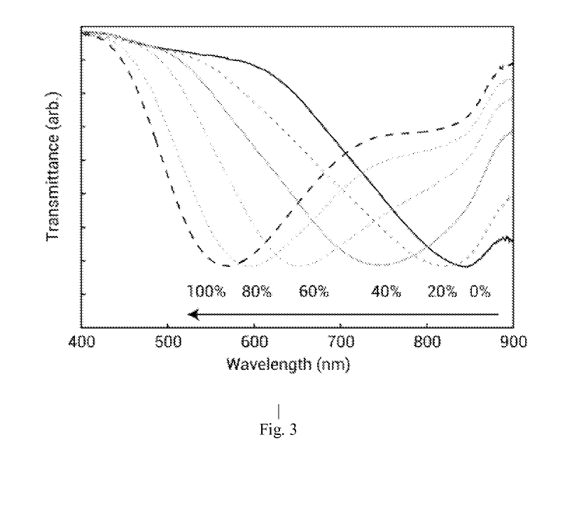

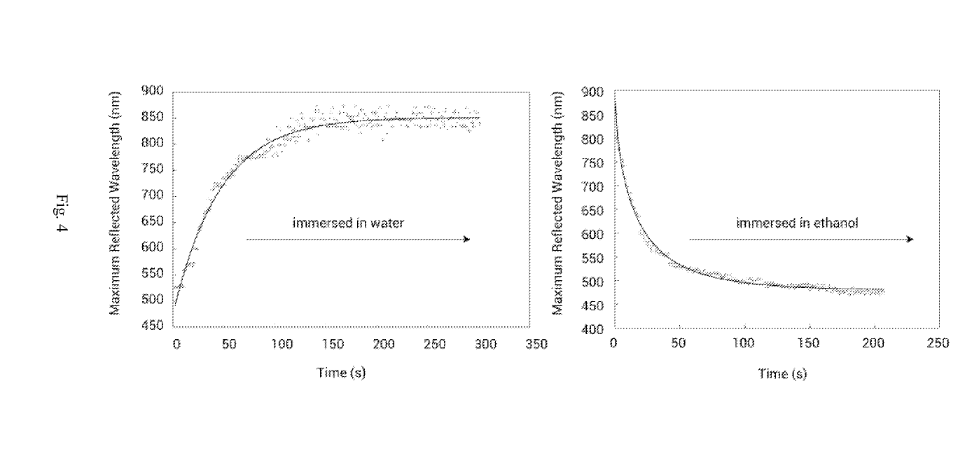

The red-shift upon swelling in water is fully reversible; allowing the polymerized films to evaporate to dryness causes a blue-shift to the original color. The helical pitch and photonic color of the hydrogel can also be reversibly controlled by soaking in various solvent mixtures. For example, soaking a swollen preparation 2 PAAm hydrogel in a range of water/ethanol mixtures causes a gradual blue-shift with increasing ethanol content (FIG. 3). A blue-shift in colour is observed upon immersion in pure ethanol.

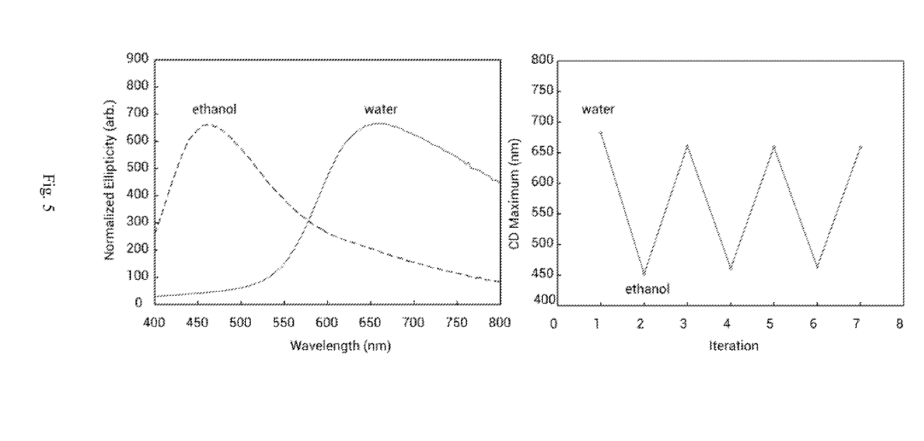

In comparison to other photonic hydrogels, which often have long response times (minutes to hours) to reach equilibrium, the swelling kinetics of the hydrogels described herein are rapid. For example, Asher and coworkers (Ben-Moshe et al. Anal. Chem. 2006, 78, 5149-5157) prepared photonic hydrogels through the self-assembly of monodisperse polystyrene colloids which respond to changes in glucose concentrations at room temperature, reaching equilibrium over a timescale of 10 to 20 minutes. For example, iridescence from a preparation 2 PAAm hydrogel reaches equilibrium after red-shifting from swelling in water after 150 s, and reaches equilibrium after blue-shifting from shrinking in ethanol (FIG. 4). Circular dichroism (CD) of preparation 2 films soaked in water and ethanol showed a strong positive ellipticity, consistent with the reflection of left-handed circularly polarized light arising from a chiral nematic phase (FIG. 5).

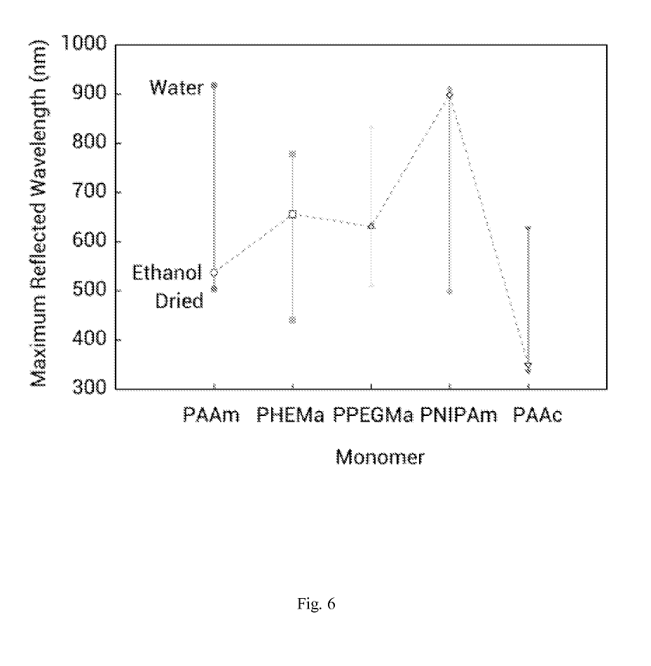

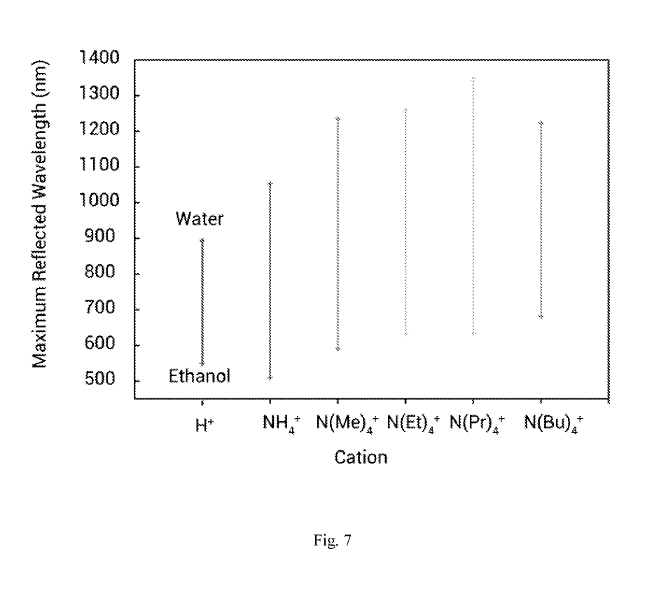

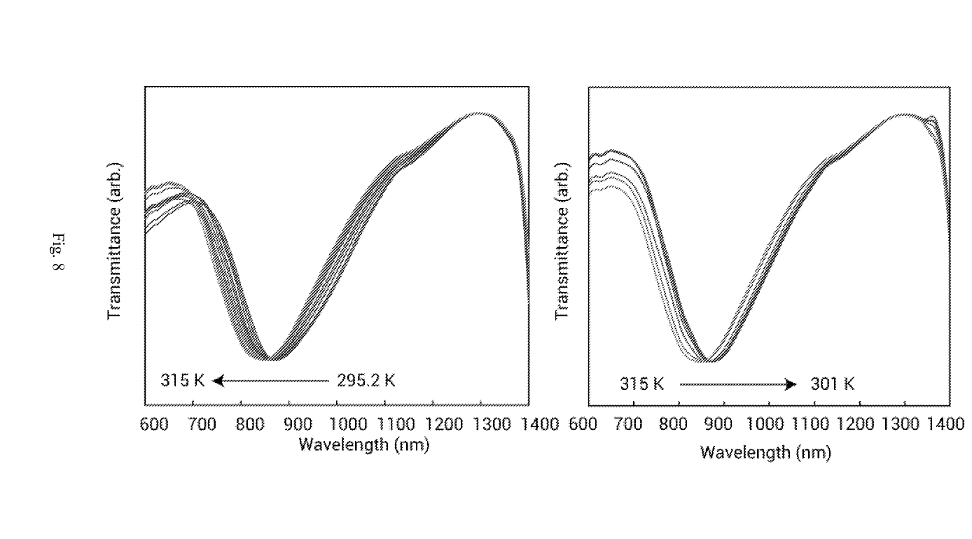

The swelling behavior of the composite hydrogels can be tailored through choice of hydrogel monomer (FIG. 6). For example, PNIPAm hydrogels do not exhibit a blue-shift in reflected colour upon immersion in ethanol. Swelling can also be controlled through chemical modification of the NCC; exchanging the protons from NCC surface sulfate groups in an as-prepared PAAm film with a hydrophobic quaternary ammonium cation results in a red-shift in the reflected color (FIG. 7). The modified films remain partially swollen in ethanol. Conversely, carrying out counterion exchange using ammonium hydroxide (i.e., a protic cation) gives a hydrogel that does not swell significantly in ethanol. Without being bound to theory, it is believed that the swelling in water and ethanol is probably a result of hydrogen-bonding interactions between the NCC, polymer and solvent.

The responsive nature of the photonic hydrogels can be tailored through choice of hydrogel monomer. For example, NCC composite hydrogels containing poly-N-isopropylacrylamide (PNIPAm, Preparation 3), a well-studied thermoresponsive hydrogel polymer, shows a reversible blue-shift in their reflected color upon heating up to 42° C. due to PNIPAm's phase transition from a swollen hydrated state to a shrunken dehydrated state (FIG. 8).

Scanning electron microscopy (SEM) provides confirmation of the formation of chiral nematic phase in the hydrogel composite. Dried preparation 1 PAAm samples showed layered domains consistent with the large helical pitch observed by POM. At higher magnification, the domains exhibit a fibrous texture consistent with the rod-shaped NCC encapsulated in polyacrylamide. Dried preparation 2 samples exhibiting photonic color showed a much shorter chiral nematic helical pitch aligned perpendicular to the surface of the film.

The materials prepared in this disclosure always have an organization that shows a positive ellipticity by CD (left-handed organization). The other organization (right-handed) is not known, but if it could be discovered, then this method should be applied to make the enantiomeric structure.

The following examples are provided to further illustrate details for the preparation and use of the hydrogels. They are not intended to be limitations on the scope of the instant disclosure in any way, and they should not be so construed. Those skilled in the art will readily understand that known variations of the conditions and processes of the following preparative procedures can be used to prepare these hydrogels.

Unless otherwise specified, the chemicals, used as received, are purchased from Aldrich (monomers) or TCI (photoinitiator) except NCC, which is prepared in-house by sulfuric acid hydrolysis of kraft bleached softwood pulp.

### EXAMPLE 1

### Synthesis of PAAm/NCC Composite

1.25 g of a 16.7 wt. % acrylamide ethanolic solution, 0.2 g of a 2.4 wt. % N,N′-methylenebisacrylamide ethanolic solution and 7.5 μL of 2,2-diethoxyacetophenone were added to 4.3 mL of a freshly sonicated 3.5% aqueous NCC suspension. The mixture was stirred for 1 h to ensure homogeneity and drop-cast on a polystyrene Petri dish. The mixture was allowed to evaporate at room temperature until the solution had decreased to 23% of its original mass (i.e., 10.5 wt. % NCC, 17.4 wt. % acrylamide and 0.34 wt. % N,N′-methylenebisacrylamide). Photopolymerization was carried out for 1 h under illumination from an 8 W 300 nm (UV-B) light source, yielding a transparent gel. POM of the polymerized gel after swelling in water shows fingerprint textures characteristic of chiral nematic ordering.

### EXAMPLE 2

### Synthesis of PAAm/NCC Composite

1.25 g of a 5.9 wt % acrylamide ethanolic solution, 0.2 g of a 2.4 wt. % N,N′-methylenebisacrylamide ethanolic solution, 7.5 μL of 2,2-diethoxyacetophenone and 150 μL of 0.25 M aqueous sodium chloride were added to 4.3 mL of a freshly sonicated 3.5% aqueous NCC suspension. The mixture was stirred for 1 h to ensure homogeneity and drop-cast on a polystyrene Petri dish. After evaporation to dryness at room temperature, photopolymerization was carried out for 1 h under illumination from a 8 W 300 nm (UV-B) light source, yielding a blue iridescent film. Soaking the film in distilled water causes a red-shift in the reflected light, shifting to 900 nm. This shift can be reversed by immersing the composite in nonaqueous solvents such as ethanol, methanol, acetone, isopropyl alcohol, etc. For example, immersing the film in ethanol causes a blue-shift to 530 nm within 30 s. Graphs of UV-vis data of the films during swelling are shown in FIG. 1. The thickness in the dry state was measured to be ca. 90 μm. After swelling it was ca. 200 μm, consistent with the change in pitch measured by UV-vis.

### Cation Exchange

After soaking in water overnight, PAAm films were immersed in a 0.1 mM aqueous solution of NR₄OH (R═H, methyl, butyl, etc.) overnight. The reacted films were removed and soaked in water to remove excess base. A graph of the change in reflected wavelength after cation exchange is shown in FIG. 7.

### EXAMPLE 3

### Synthesis of PNIPAm/NCC Composite

1.25 g of a 5.9 wt. % N-isopropylacrylamide ethanolic solution, 0.2 g of a 2.4 wt. % N,N′-methylenebisacrylamide ethanolic solution, 7.5 μL of 2,2-diethoxyacetophenone and 150 μL of 0.25 M aqueous sodium chloride were added to 4.3 mL of a freshly sonicated 3.5% aqueous NCC suspension. The mixture is stirred for 1 h to ensure homogeneity and drop-cast on a polystyrene Petri dish. After evaporation at room temperature, photopolymerization was carried out for 1 h under illumination from an 8 W 300 nm (UV-B) light source, yielding a blue iridescent film. After swelling the films in distilled water, heating the film from room temperature up to ca. 39° C. causes a reversible blue-shift in the reflected color. Graphs of the UV-vis data during this heating process are shown in FIG. 8.

### EXAMPLE 4

### Synthesis of PPEGMa/NCC Composite

1.25 g of a 5.9 wt. % Poly(ethylene glycol) methacrylate ethanolic solution (average Mₙ 500), 0.2 g of a 2.4 wt. % Poly(ethylene glycol) dimethacrylate ethanolic solution (average Mₙ 550), 7.5 μL of 2,2-diethoxyacetophenone and 150 μL of 0.25 M aqueous sodium chloride were added to 4.3 mL of a freshly sonicated 3.5% aqueous NCC suspension. The mixture was stirred for 1 h to ensure homogeneity and drop-cast on a polystyrene Petri dish. After evaporation to dryness at room temperature, photopolymerization was carried out for 1 h under illumination from an 8 W 300 nm (UV-B) light source, yielding a blue iridescent film.

### EXAMPLE 5

### Synthesis of PHEMa/NCC Composite

1.25 g of a 5.9 wt. % hydroxyethylmethacrylate ethanolic solution, 0.2 g of a 2.4 wt. % N,N′-methylenebisacrylamide ethanolic solution, 7.5 μL of 2,2-diethoxyacetophenone and 150 μL of 0.25 M aqueous sodium chloride were added to 4.3 mL of a freshly sonicated 3.5% aqueous NCC suspension. The mixture was stirred for 1 h to ensure homogeneity and drop-cast on a polystyrene Petri dish. After evaporation to dryness at room temperature, photopolymerization was carried out for 1 h under illumination from an 8 W 300 nm (UV-B) light source, yielding a blue iridescent film.

### EXAMPLE 6

### Synthesis of PAAc/NCC Composite

1.25 g of a 5.9 wt. % acrylic acid ethanolic solution, 0.2 g of a 2.4 wt. % N,N′-methylenebisacrylamide ethanolic solution, 7.5 μL of 2,2-diethoxyacetophenone and 150 μL of 0.25 M aqueous sodium chloride are added to 4.3 mL of a freshly sonicated 3.5% aqueous NCC suspension. The mixture was stirred for 1 h to ensure homogeneity and drop-cast on a polystyrene Petri dish. After evaporation to dryness at room temperature, photopolymerization was carried out for 1 h under illumination from an 8 W 300 nm (UV-B) light source, yielding a blue iridescent film.

While the disclosure has been described in connection with specific embodiments thereof, it is understood that it is capable of further modifications and that this application is intended to cover any variation, use, or adaptation of the disclosure following, in general, the principles of the disclosure and including such departures from the present disclosure that come within known, or customary practice within the art to which the disclosure pertains and as may be applied to the essential features hereinbefore set forth, and as follows in the scope of the appended claims.

1. A composite hydrogel comprising a polymer matrix and an intercalated network of nanocrystalline cellulose (NCC) substantially uniformly dispersed within said matrix wherein said polymer matrix is swellable in an aqueous and/or organic solvent and said polymer matrix is comprising at least one cross-linked hydrophilic polymer; wherein said NCC is organized in a chiral nematic structure.

2. The composite as defined in claim 1, wherein said polymer matrix is an acrylic acid and/or acrylate-based matrix.

3. A process comprising
preparing a solution of a hydrophilic monomer, a cross-linker and an initiator in a solvent;
providing a suspension of NCC in a solvent;
mixing said solution and said suspension to provide homogeneity;
optionally removing at least some of said solvent(s); and
polymerizing said monomer and crosslinking said cross-linker to form a composite hydrogel.

4. The process as defined in claim 3 wherein the mononer is an acrylic acid and/or acrylate-based monomer.

5. The process as defined in claim 3, wherein the mononer is acrylamide (AAm), N-isopropylacrylamide (NIPAm), hydroxyethylmethacrylate (HEMa), poly(ethylene glycol) methacrylate (PEGMa), acrylic acid (AAc), vinylpyrrolidone, N-vinylformamide (NVF) or a mixture thereof.

6. The process as defined in claim 3, wherein the initiator is a photoinitiator.

7. The process as defined in claim 3, further comprising adding a salt before the step of polymerizing the monomer.

8. The process as defined in claim 3, further comprising effecting a cation exchange step after forming of said composite hydrogel.

9-10. (canceled)

11. An article of manufacture comprising the composite hydrogel as defined in claim 1.

12. The article as defined in claim 11, wherein said article is a sensor, a tunable optical filter, or an electrophoresis gels for separating chiral or nonchiral species, displaying features or templating a nanomaterial.

13. The process as defined in claim 3 wherein the cross-linker comprises prop-2-enoyl functional groups.

14. The process as defined in claim 3 wherein the cross-linker comprises N,N′-methylenebisacrylamide or ethyleneglycol dimethacrylate.

15. The process as defined in claim 3 wherein the initiator is a photoinitiator comprising 2,2-diethoxyacetophenone or 2-hydroxy-1-[4-(2-hydroxyethoxy)phenyl]-2-methyl-1-propanone.

16. The process of claim 3 comprising
preparing a solution of a hydrophilic monomer, a cross-linker and an initiator in an organic solvent,
wherein said mononer is acrylamide (AAm), N-isopropylacrylamide (NIPAm), hydroxyethylmethacrylate (HEMa), poly(ethylene glycol) methacrylate (PEGMa), acrylic acid (AAc), vinylpyrrolidone, N-vinylformamide (NVF) or a mixture thereof,
said cross-linker comprises at least two end-terminal prop-2-enoyl functional groups and
said organic solvent is miscible with water or an aqueous solvent;
providing a suspension of NCC in an aqueous solvent;
mixing said solution and said suspension to provide homogeneity;
optionally removing at least some of said solvent(s); and
polymerizing said monomer and crosslinking said cross-linker to form said composite hydrogel.
